(19) United States
(12) Patent Application Publication
(10) Pub. No.: US 2019/0087677 A1
(43) Pub. Date: Mar. 21, 2019

(54) METHOD AND SYSTEM FOR CONVERTING AN IMAGE TO TEXT

(71) Applicant: Ramot at Tel-Aviv University Ltd., Tel-Aviv (IL)

(72) Inventors: Lior WOLF, Herzlia (IL); Arik POZNANSKI, Tel-Aviv (IL)

(73) Assignee: Ramot at Tel-Aviv University Ltd., Tel-Aviv (IL)

(21) Appl. No.: 16/086,646

(22) PCT Filed: Feb. 23, 2017
(86) PCT No.: PCT/IL2017/050230

§ 371 Date: Sep. 20, 2018

Related U.S. Application Data
(60) Provisional application No. 62/312,560, filed on Mar. 24, 2016.

(51) Int. Cl. G06K 9/34; G06K 9/62; G06F 17/30; G06N 3/04

(52) U.S. Cl. CPC G06K 9/344; G06K 9/6256; G06K 2209/015; G06N 3/0454; G06F 17/30253

(57) ABSTRACT

In a method of converting an input image patch to a text output, a convolutional neural network (CNN) is applied to the input image patch to estimate an n-gram frequency profile of the input image patch. A computer-readable database containing a lexicon of textual entries and associated n-gram frequency profiles is accessed and searched for an entry matching the estimated frequency profile. A text output is generated responsively to the matched entries.

### RELATED APPLICATION

This application claims the benefit of priority under of U.S. Provisional Patent Application No. 62/312,560 filed Mar. 24, 1026 the contents of which are incorporated herein by reference in their entirety.

### FIELD AND BACKGROUND OF THE INVENTION

The present invention, in some embodiments thereof, relates to image processing and, more particularly, but not exclusively, to a method and system for converting an image to text.

Optical character recognition (OCR) generally involves translating images of text into an encoding representing the actual text characters. OCR techniques for text based on a Latin script alphabet are widely available and provide very high success rates. Handwritten text generally presents different challenges for recognition than typewritten text.

Known in the art are handwriting recognition techniques that are based on Recurrent Neural Networks (RNNs) and their extensions such as Long-Short-Term-Memory (LSTM) networks, Hidden Markov Models (HMMs), and combinations thereof [6, 11, 12, 14, 35, and 49].

Another method, published by Almazán et al. [3], encodes an input word image as Fisher Vectors (FV), which can be viewed as an aggregation of the gradients of a Gaussian Mixture Model (GMM) over low-level descriptors. It then trains a set of linear Support Vector Machine (SVM) classifiers, one per each binary attribute contained in a set of word properties. Canonical Correlation Analysis (CCA) is used to link the vector of predicted attributes and the binary attributes vector generated from the actual word.

An additional method, published by Jaderberg et al. [26], uses convolutional neural networks (CNNs) trained on synthetic data for Scene Text Recognition.

### SUMMARY OF THE INVENTION

According to an aspect of some embodiments of the present invention there is provided a method of converting an input image patch to a text output. The method comprises: applying a convolutional neural network (CNN) to the input image patch to estimate an n-gram frequency profile of the input image patch; accessing a computer-readable database containing a lexicon of textual entries and associated n-gram frequency profiles; searching the database for an entry matching the estimated frequency profile; and generating a text output responsively to the matched entries.

According to some embodiments of the invention the CNN is applied directly to raw pixel values of the input image patch.

According to some embodiments of the invention at least one of the n-grams is a sub-word.

According to some embodiments of the invention the CNN comprises a plurality of subnetworks, each trained for classifying the input image patch into a different subset of attributes.

According to some embodiments of the invention the CNN comprises a plurality of convolutional layers trained for determining existence of n-grams in the input image patch, and a plurality of parallel subnetworks being fed by the convolutional layers and trained for determining a position of the n-grams in the input image patch.

According to some embodiments of the invention each of the subnetworks comprises a plurality of fully-connected layers.

According to some embodiments of the invention the CNN comprises multiple parallel fully connected layers.

According to some embodiments of the invention the CNN comprises a plurality of subnetworks, each subnetwork comprises a plurality of fully connected layers, and being trained for classifying the input image patch into a different subset of attributes.

According to some embodiments of the invention for at least one of the subnetworks, the subset of attributes comprises a rank of an n-gram, a segmentation level of the input image patch, and a location of a segment of the input image patch containing the n-gram.

According to some embodiments of the invention the searching comprises applying a canonical correlation analysis (CCA).

According to some embodiments of the invention the method comprises obtaining a representation vector directly from a plurality of hidden layers of the CNN, wherein the CCA is applied to the representation vector.

According to some embodiments of the invention the plurality of hidden layers comprises multiple parallel fully connected layers, wherein the representation vector is obtained from a concatenation of the multiple parallel fully connected layers.

According to some embodiments of the invention the input image patch contains a handwritten word. According to some embodiments of the invention the input image patch contains a printed word. According to some embodiments of the invention the input image patch contains a handwritten word and a printed word.

According to some embodiments of the invention the method comprises receiving the input image patch from a client computer over a communication network, and transmitting the text output to the client computer over the communication network to be displayed on a display by the client computer.

According to an aspect of some embodiments of the present invention there is provided a method of converting an image containing a corpus of text to a text output, the method comprises: dividing the image into a plurality of image patches; and for each image patch, executing the method as delineated above and optionally and preferably as exemplified below, using the image patch as the input image patch, to generate a text output corresponding to the patch. According to some embodiments of the invention the method comprises receiving the image containing the corpus of text from a client computer over a communication network, and transmitting the text output corresponding to each patch to the client computer over the communication network to be displayed on a display by the client computer.

According to an aspect of some embodiments of the present invention there is provided a method of extracting classification information from a dataset. The method comprises: training a convolutional neural network (CNN) on the dataset, the CNN having a plurality of convolutional layers, and a first subnetwork containing at least one fully connect layer and being fed by the convolutional layers; enlarging the CNN by adding thereto a separate subnetwork, also containing at least one fully connect layer, and also being fed by the convolutional layers, in parallel to the first subnetwork; and training the enlarged CNN on the dataset.

According to some embodiments of the invention wherein the dataset is a dataset of images. According to some embodiments of the invention the dataset is a dataset of images containing handwritten symbols. According to some embodiments of the invention the dataset is a dataset of images containing printed symbols. According to some embodiments of the invention the dataset is a dataset of images containing handwritten symbols and images containing printed symbols. According to some embodiments of the invention the dataset is a dataset of images, wherein at least one image of the dataset contains both handwritten symbols and printed symbols.

According to some embodiments of the invention the method comprises augmenting the dataset prior to the training.

According to an aspect of some embodiments of the present invention there is provided a computer software product. The computer software product comprises a computer-readable medium in which program instructions are stored, which instructions, when read by a server computer, cause the server computer to receive an input image patch and to execute the method as delineated above and optionally and preferably as exemplified below.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of example only, with reference to the accompanying drawings and images. With specific reference now to the drawings and images in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method suitable for converting an input image to a text output, according to various exemplary embodiments of the present invention;

FIG. 2 is a schematic illustration of a representative example of an n-gram frequency profile that can be associated with the textual entry “optimization” in a computer-readable database, according to some embodiments of the present invention;

FIG. 3 which is a schematic illustration of a CNN, according to some embodiments of the present invention;

FIG. 4 is a schematic illustration of a client computer and a server computer according to some embodiments of the present invention;

FIG. 5 is a schematic illustration of an example of attributes which were set for the word “optimization,” and used in experiments performed according to some embodiments of the present invention;

FIGS. 6A-B are schematic illustrations of a structure of the CNN used in experiments performed according to some embodiments of the present invention; and

FIG. 7 shows an augmentation process performed according to some embodiments of the present invention.

### DESCRIPTION OF SPECIFIC EMBODIMENTS OF THE INVENTION

The present invention, in some embodiments thereof, relates to image processing and, more particularly, but not exclusively, to a method and system for converting an image to text.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

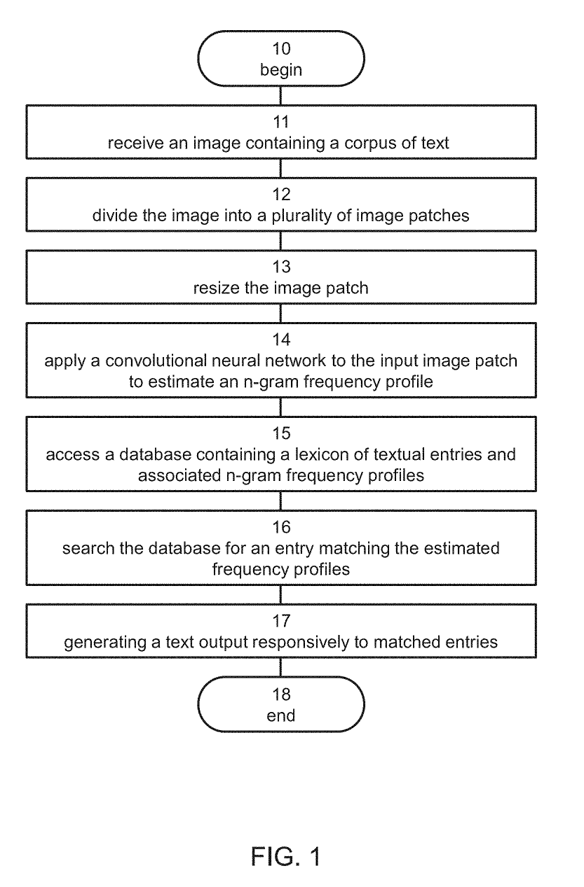

FIG. 1 is a flowchart diagram of a method suitable for converting an input image to a text output, according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

At least part of the operations described herein can be can be implemented by a data processing system, e.g., a dedicated circuitry or a general purpose computer, configured for receiving data and executing the operations described below. At least part of the operations can be implemented by a cloud-computing facility at a remote location.

Computer programs implementing the method of the present embodiments can commonly be distributed to users by a communication network or on a distribution medium such as, but not limited to, a floppy disk, a CD-ROM, a flash memory device and a portable hard drive. From the communication network or distribution medium, the computer programs can be copied to a hard disk or a similar intermediate storage medium. The computer programs can be run by loading the code instructions either from their distribution medium or their intermediate storage medium into the execution memory of the computer, configuring the computer to act in accordance with the method of this invention. All these operations are well-known to those skilled in the art of computer systems.

Processing operations described herein may be performed by means of processer circuit, such as a DSP, microcontroller, FPGA, ASIC, etc., or any other conventional and/or dedicated computing system.

The method of the present embodiments can be embodied in many forms. For example, it can be embodied in on a tangible medium such as a computer for performing the method operations. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

Referring now to FIG. 1, the method begins at 10 and optionally and preferably continues to 11 at which an image containing a corpus of text defined over an alphabet is received. The alphabet is a set of symbols, including, without limitation, characters, accent symbols, digits and/or punctuation symbols. Preferably, the image contains a corpus of handwritten text, in which case the alphabet is a set of handwritten symbols, but images of printed text defined over a set of printed symbols are also contemplated, in some embodiments of the present invention. Further contemplated are images containing both handwritten and printed texts.

The image is preferably a digital image and can be received from an external source, such as a storage device storing the image in a computer-readable form, and/or be transmitted to a data processor executing the method operations over a communication network, such as, but not limited to, the internet.

The method continues to 12 at which received image is divided into a plurality of image patches. Typically, the image patches are sufficiently small to include no more than a few tens to a few hundred pixels along any direction over the image plane. For example, each patch can be from about 80 to about 120 pixels in length and from about 30 to about 40 pixels in width. Other sizes are also contemplated. Preferably, but not necessarily, 12 is executed such that all patches are of the same size. Typically, at least a few of the patches contain a single word of the corpus, optionally and preferably a single handwritten word of the corpus. Thus, operation 12 can include an image processing operations, such as, but not limited to, filtering, in which locations of textual words over the image are identified, wherein the image patches are defined according to this identification.

Both operations 11 and 12 are optional. In some embodiments of the present invention, rather than receiving an image of text corpus, the method receives from the external source an image patch as input. In these embodiments, operations 11 and 12 can be skipped.

Herein, “input image patch” refers to an image patch which has been either generated by the method, for example, at 12, or received from an external source. When operations 11 and 12 are executed, operations described below with respect to the input image patch, are optionally and preferably repeated for each of at least some of the image patches, more preferably all the image patches, obtained at 12.

The method optionally and preferably continues to 13 at which the input image patch is resized. This operation is particularly useful when operation 12 results in patches of different sizes or when the image patch is received as input from an external source. The resizing can include stretching or shrinking along any of the axes of the image patch to a predetermined width, a predetermined length and/or a predetermined diagonal, as known in the art. It is appreciated, however, that it is not necessary for all the patches to be of the same size. Some embodiments of the invention are capable of processing image patches of different sizes.

At 14, a convolutional neural network (CNN) is applied to the input image patch to estimate an n-gram frequency profile of the input image patch. Optionally, but not necessarily, the CNN is a fully convolutional neural network. This embodiment is particularly useful when the patches are of different sizes.

As used herein, an n-gram is a subsequence of n items from a given sequence, where n is an integer greater than or equal to 1. For example, if the sequence is a sequence of symbols (such as, but not limited to, textual characters) defining a word, the n-gram refers to a subsequence of characters forming a sub-word. If the sequence is a sequence of words defining a sentence the n-gram refers to a subsequence of words forming a part of a sentence.

While the embodiments below are described with a particular emphasis to situations in which the n-gram is a subsequence of characters forming a sub-word (particularly useful when, but not only, the input image patch contains a single word), embodiments in which the n-gram is a subsequence of words forming a part of a sentence are also contemplated.

The number n of an n-gram is referred to as the rank of the n-gram. An n-gram with rank 1 (a 1-gram) is referred to as a unigram, an n-gram of rank 3 (a 2-gram) is referred to as a bigram, and an n-gram of rank 3 (a 3-gram) is referred to as a trigram.

As used herein, an “n-gram frequency profile” refers to a set of data elements indication the level, and optionally and preferably also the position, of existence of each of a plurality of n-grams in a particular sequence. For example, if the sequence is a sequence of symbols defining a word, the frequency profile of the word, can include the number of times each of a plurality of n-grams appears in the word, or, more preferably, the set of positions or word segments that contain each of the n-grams.

A data element of an n-gram frequency profile of the image patch is also referred to herein as an “attribute” of the image patch. Thus, an n-gram frequency profile constitutes a set of attributes.

In various exemplary embodiments of the invention the CNN is applied directly to raw pixel values of the input image patch. This is unlike Almazán et al. supra in which the image has to be first encoded as a Fisher vector, before the application of SVMs.

The CNN is optionally and preferably pre-trained to estimate n-gram frequency profiles with respect to n-grams that are defined over a specific alphabet, a subset of which is contained in the image patches to which the CNN is designed to be applied.

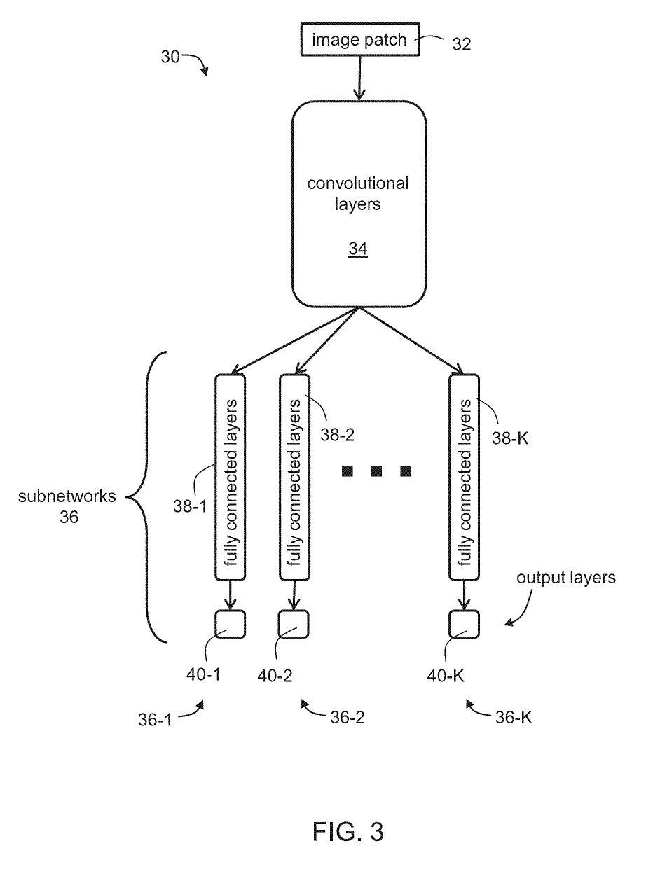

In some embodiments of the present invention the CNN comprises a plurality of convolutional layers trained for determining existence of n-grams in the input image patch, and a plurality of parallel subnetworks being fed by the convolutional layers and trained for determining an approximate position of n-grams in the input image patch. A CNN suitable for the present embodiments is described below, with reference to FIG. 3 and further exemplified in the Examples section that follows.

The method continues to 15 at which a computer-readable database containing a lexicon of textual entries and associated n-gram frequency profiles is accessed. When the n-gram is a sub-word, the textual entries of the lexicon are optionally and preferably words, either a subset or a complete set of all possible words of the respective language. Each of the words in the lexicon is associated with an n-gram frequency profile that describes the respective word.

For example, when the lexicon includes words in the English language and the one of the words is, say, “BABY”, it can be associated with a frequency profile including a set of one or more attributes selected from a list consisting of at least the following attributes: (i) the unigram “B” appears twice, (ii) the unigram “B” appears one time in the first half of the word, (iii) the unigram “B” appears one time in the second half of the word, (iv) the unigram “A” appears once, (v) the unigram “A” appears once in the first half of the word, (vi) the unigram “Y” appears once, (vii) the unigram “Y” appears once in the second half of the word, (viii) the unigram “Y” appears at the end of the word, (ix) the bigram “BA” appears once, (x) the bigram “BA” appears once in the first half of the word, (xi) the bigram “BY” appears once, (xii) the bigram “BY” appears once in the second half of the word, (xiii) the bigram “AB” appears once, (xiv) the bigram “AB” appears once in the middle segment of the word, (xv) the trigram “BAB” appears once, (xvi) the trigram “BAB” appears once at the first three quarters of the word, (xvii) the trigram “ABY” appears once, etc.

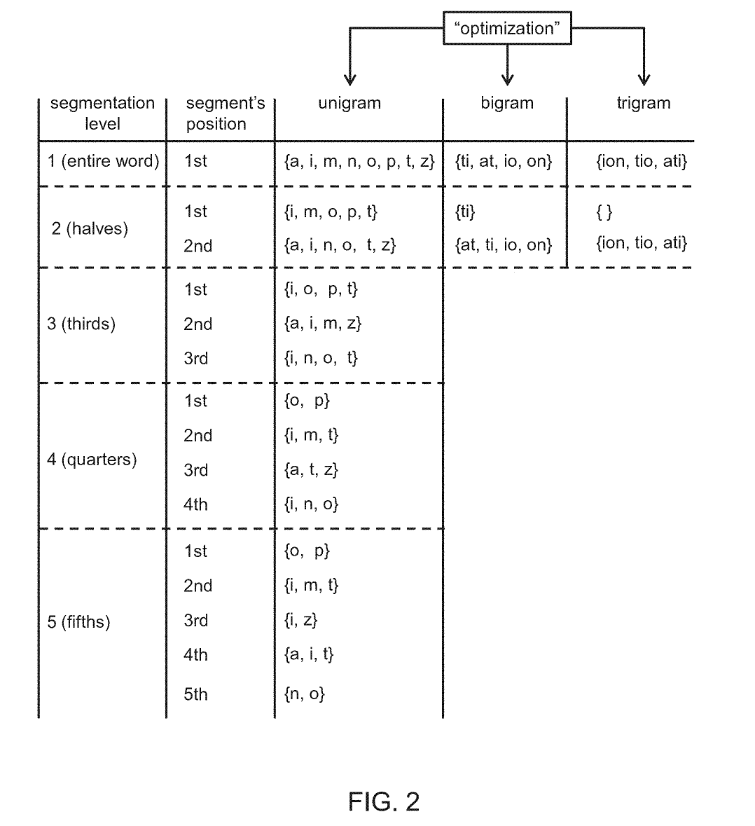

It is to be understood that a particular frequency profile that is associated with a particular lexicon textual entry need not necessarily include all possible attributes that may describe the lexicon textual entry (although such embodiments are also contemplated). Rather, only n-grams that are sufficiently frequent throughout the lexicon are typically used. A representative example of an n-gram frequency profile that can be associated with the textual entry “optimization” in the computer-readable database is illustrated in FIG. 2. The n-gram frequency profile includes subsets of attributes that correspond to unigrams in the word, subsets of attributes that correspond to bigrams in the word, and subsets of attributes that correspond to trigrams in the word. Attributes corresponding to n-grams of rank higher than 3 are also contemplated. As shown, some data values are not included (e.g., “mi,” “opt”) in the profile since they are less frequent in the English language than others. As stated, the number of occurrences of a particular n-gram in the lexicon textual entry can also be included in the profile. These have been omitted from FIG. 2 for clarity of presentation, but one of ordinary skills in the art, provided with the details described herein would know how to modify the profile in FIG. 2 to include also the number of occurrences. For example, the upper-left subset of unigrams in FIG. 2 can be modified to read, e.g., {{a, 1}, {i, 2), {m, 1}, {n, 1}, {o, 2}, {p, 1}, (t, 2}, {z, 1}}, indicating that the unigram “a” appears only once in the word, the unigram “i” appears twice in the word, and so on.

The method continues to 16 at which searching database for an entry matching estimated frequency profiles. The set of attributes in the estimated profile can be directly compared to the attributes of database profile. However, while such a direct comparison is contemplated in some embodiments of the present invention, it was found by the Inventors that the use of Canonical Correlation Analysis (CCA) is a more preferred technique. A CCA is a computational technique that helps in weighing data elements and in determining dependencies between data elements. In the context optionally and preferably the CCA may be utilized to identify dependencies between attributes and between subsets of attributes, and optionally also to weigh attributes or subsets of attributes according to their discriminative power.

In canonical correlation analysis, the attributes of the database profile and the attributes of the estimated profile are used to form separate representation vectors. The CCA finds a common linear subspace to which both the attributes of the database profile and the attributes of the estimated profile are projected, such that matching words are projected as close as possible. This can be done, for example, by selecting the coefficients of the linear combinations to increase the correlation between the linear combinations. In some embodiments of the present invention a regularized CCA is employed.

Representative Examples of CCA algorithms that can be used according to some embodiments of the present invention are found in [52].

The CCA can be applied to a vector generated by one or more output layers of the CNN. Alternatively, since CCA does not require the matching vectors of the two domains to be of the same type or size, the CCA can be applied to a vector generated by one or more hidden layers of the CNN. In some embodiments of the present invention the CCA is applied to a vector generated by a concatenation of several parallel fully connected layers of the CNN.

The method continues to 17 at which generating a text output responsively to matched entries. The text output is preferably a printed word that matches the word of the input image. The text output can be displayed on a local display device or transmitted to a client computer for displaying by the client computer on a display. When the method receives an image which is divided into patches, the text output corresponding to each image patch can be displayed separately. Alternatively, two or more, e.g., all, of the text outputs can be combined to provide a textual corpus which is then displayed. Thus, for example, the method can receive an image of a document, and generate a textual corpus corresponding to the contents of the image.

The method ends at 18.

Reference is now made to FIG. 3 which is a schematic illustration of a CNN 30, according to some embodiments of the present invention. CNN 30 is particularly useful in combination with the method described above, for estimating an n-gram frequency profile of an input image patch 32.

In various exemplary embodiments of the invention CNN 30 comprises a plurality of convolutional layers 34, which is fed by the image patch 32, and a plurality of subnetworks 36, which are fed by convolutional layers 34. The number of convolutional layers in CNN 30 is preferably at least five or at least six or at least seven or at least eight, e.g., nine or more convolutional layers. Each of subnetworks 36 is interchangeably referred to herein as a “branch” of CNN 30. The number of branches of CNN 30 is denoted K. Typically, K is at least 7 or at least 8 or at least 9 or at least 10 or at least 11 or at least 12 or at least 12 or at least 13 or at least 14 or at least 15 or at least 16 or at least 17 or at least 18, e.g., 19.

Image data of the image patch 32 is preferably received by convolution directly by the first layer of convolutional layers 34, and each of the other layers of layers 34 receive data by convolution from its previous layer, where the convolution is executed using a convolutional kernel as known in the art. The size of the convolutional kernel is preferably at most 5×5 more preferably at most 4×4, for example, 3×3. Other kernel sizes are also contemplated. The activation function can be of any type, including, without limitation, maxout, ReLU and the like. In experiments performed by the Inventors, maxout activation was employed.

Each of subnetworks 36-1, 36-2, . . . , 36-K, optionally and preferably comprises a plurality 38-1, 38-2 . . . 38-K of fully connected layers, where the first layer in each of pluralities 38-1, 38-2 . . . 38-K is fed, in a fully connected manner, by the same last layer of convolutional layers 34. Thus, subnetworks 36 are parallel subnetworks. The number of fully connected layers in each of pluralities 38-1, 38-2 . . . 38-K is preferably at least two, e.g., three or more fully connected layers. CNN 30 can optionally and preferably also include a plurality of output layers 40-1, 40-2 . . . 40-N, each being fed by the last fully connected layer of the respective branch. In some embodiments of the present invention each output layer comprises a plurality of probabilities that, can be obtained by an activation function having a saturation profile, such as, but not limited to, a sigmoid, a hyperbolic tangent function and the like.

The convolutional layers 34 are preferably trained for determining existence of n-grams in the input image patch 32, and the fully connected layers 38 are preferably trained for determining positions of n-grams in the input image patch 32. Preferably each of pluralities 38-1, 38-2 . . . 38-K is trained for classifying the input image patch 32 into a different subset of attributes. Typically, a subset of attributes can comprise a rank of an n-gram (e.g., unigram, bigram, trigram, etc.), a segmentation level of the input image patch (halves, thirds, quarters, fifths, etc.), and a location of a segment of the input image patch (first half, second half, first third etc.) containing the n-gram. For example, plurality 38-1 can for classifying the input image patch 32 into the subset of attributes including unigrams appearing anywhere in the word (see, e.g., the upper-left subset in FIG. 2), plurality 38-2 can for classifying the input image patch 32 into the subset of attributes including unigrams appearing in the first half of the word (see, e.g., the second subset in the left column FIG. 2), etc. Detailed examples of a CNNs with 7 and 19 pluralities of fully connected layers according to some embodiments of the present invention is provided in the Examples section that follows. Unlike conventional CNNs that do not include parallel branches or include branches only during training, CNN 30 of the present embodiments includes a plurality of branches that are utilized both during training and during prediction phase.

As stated, the present embodiments contemplate applying CCA either to a vector generated by the output layers 40, or to a vector generated by one or more of the hidden layers. The vector can be generated by arranging the values of the respective layer in the form of a one-dimensional array. In a preferred implementation, the CCA is applied to a vector generated by a concatenation of several fully connected layers, preferably one from each of at least a few of subnetworks 36-1, 36-2, . . . , 36-K. In some embodiments of the present invention the penultimate fully connected layers are concatenated.

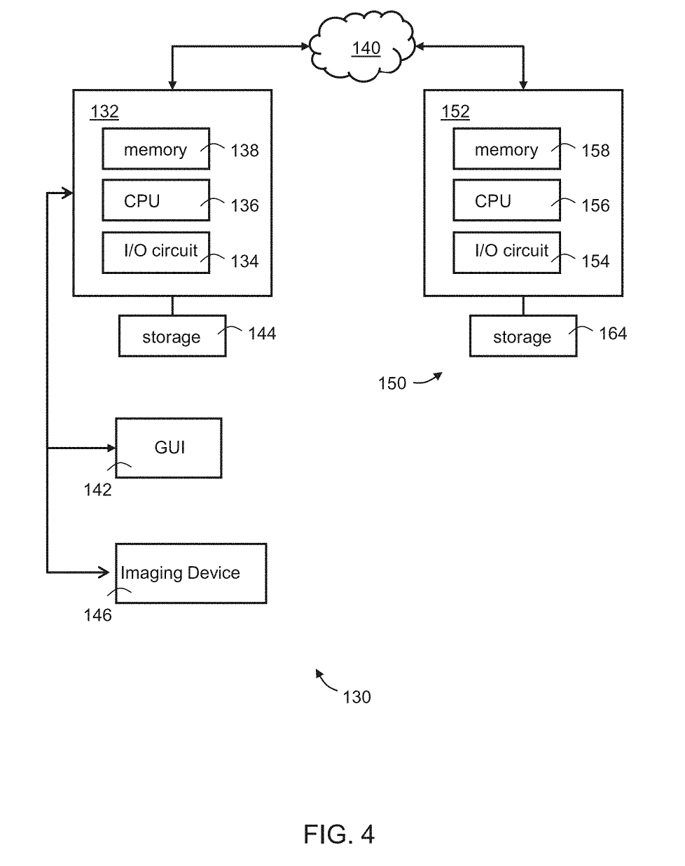

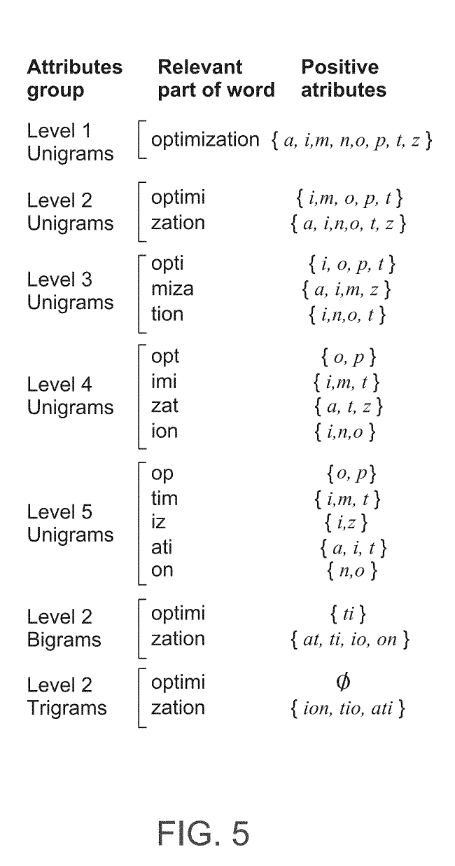

FIG. 4 is a schematic illustration of a client computer 130 having a hardware processor 132, which typically comprises an input/output (I/O) circuit 134, a hardware central processing unit (CPU) 136 (e.g., a hardware microprocessor), and a hardware memory 138 which typically includes both volatile memory and non-volatile memory. CPU 136 is in communication with I/O circuit 134 and memory 138. Client computer 130 preferably comprises a graphical user interface (GUI) 142 in communication with processor 132. I/O circuit 134 preferably communicates information in appropriately structured form to and from GUI 142. Also shown is a server computer 150 which can similarly include a hardware processor 152, an I/O circuit 154, a hardware CPU 156, a hardware memory 158. I/O circuits 134 and 154 of client 130 and server 150 computers can operate as transceivers that communicate information with each other via a wired or wireless communication. For example, client 130 and server 150 computers can communicate via a network 140, such as a local area network (LAN), a wide area network (WAN) or the Internet. Server computer 150 can be in some embodiments be a part of a cloud computing resource of a cloud computing facility in communication with client computer 130 over the network 140. Further shown, is an imaging device 146 such as a camera or a scanner that is associated with client computer 130.

GUI 142 and processor 132 can be integrated together within the same housing or they can be separate units communicating with each other. Similarly, imaging device 146 and processor 132 can be integrated together within the same housing or they can be separate units communicating with each other.

GUI 142 can optionally and preferably be part of a system including a dedicated CPU and I/O circuits (not shown) to allow GUI 142 to communicate with processor 132. Processor 132 issues to GUI 142 graphical and textual output generated by CPU 136. Processor 132 also receives from GUI 142 signals pertaining to control commands generated by GUI 142 in response to user input. GUI 142 can be of any type known in the art, such as, but not limited to, a keyboard and a display, a touch screen, and the like. In preferred embodiments, GUI 142 is a GUI of a mobile device such as a smartphone, a tablet, a smartwatch and the like. When GUI 142 is a GUI of a mobile device, processor 132, the CPU circuit of the mobile device can serve as processor 132 and can execute the code instructions described herein.

Client 130 and server 150 computers can further comprise one or more computer-readable storage media 144, 164, respectively. Media 144 and 164 are preferably non-transitory storage media storing computer code instructions as further detailed herein, and processors 132 and 152 execute these code instructions. The code instructions can be run by loading the respective code instructions into the respective execution memories 138 and 158 of the respective processors 132 and 152. Storage media 164 preferably also store a library of reference data as further detailed hereinabove.

Each of storage media 144 and 164 can store program instructions which, when read by the respective processor, cause the processor to receive an input image patch and to execute the method as described herein. In some embodiments of the present invention, an input image containing a textual content is generated by imaging device 130 and is transmitted to processor 132 by means of I/O circuit 134. Processor 132 can convert the image to a text output as further detailed hereinabove and display the text output, for example, on GUI 142. Alternatively, processor 132 can transmit the image over network 140 to server computer 150. Computer 150 receives the image, convert the image to a text output as further detailed hereinabove and transmits the text output back to computer 130 over network 140. Computer 130 receives the text output and displays it on GUI 142.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

In this Example, the n-gram frequency profile of an input image of a handwritten word is estimated using a CNN. Frequencies for unigrams, bigrams and trigrams are estimated for the entire word and for parts of it. Canonical Correlation Analysis is then used to match the estimated profile to the true profiles of all words in a large dictionary.

CNNs are trained in a supervised way. The first question when training it, is what type of supervision to use. At least for handwriting recognition, the supervision can include attribute-based encoding, wherein the input image is described as having or lacking a set of n-grams in some spatial sections of the word. Binary attributes may check, e.g., whether the word contains a specific n-gram in some part of the word. For example, one such property may be: does the word contain the bigram “ou” in the second half of the word? An examined word for which the answer is positive is referred to as “ingenious,” and an examined word for which the answer is negative is referred to as “outstanding.”

In the present Example, the CNN is optionally and preferably employed directly over raw pixel values. To improve the performance of the method, specialized subnetworks that focus on subsets of the attributes have been employed in this Example. In various exemplary embodiments of the invention gradual training is employed for training the CNN.

In multiple experiments performed by the Inventors, it was found that the obtained CNN is useful for converting many types of handwriting images to textual output, wherein the same architecture can be applied to many handwriting benchmark datasets, and achieves a very sizable improvement over conventional techniques.

Unlike the technique disclosed in Almazán et al., the method in this example train over raw pixel values and additionally we benefit from using a single classifier that predicts all the binary attributes, instead of using one classifier per attribute. Instead of relying on the probabilities at the output layers of the CNN, CCA is optionally and preferably applied to a representation vector obtained from one or more of the hidden layers, namely below the output layers.

Unlike Jaderberg et al., CCA is employed to factor out dependencies between attributes. Further unlike Jaderberg et al., the spatial location of the n-gram inside the word is determined and used in the recognition. Further unlike Jaderberg et al., the network structure optionally and preferably employs multiple parallel fully connected layers, each handling a different set of attributes. Additionally unlike Jaderberg et al., the method of the present embodiments can use a considerably less amount of n-grams than used in Jaderberg et al.

### Method

In offline handwriting recognition, two disjoint sets referred to as train and test are used. Each of the sets may contain pairs (I, t) such that I is an image and t is its textual transcription. The goal is to build a system which, given an image, produces a prediction of the image transcription.

The construction of the system can be done using information from the train set only.

To evaluate the performance, the method was applied to the test images and the predicted transcription was compared with the actual image transcription for each image. The result of such an evaluation can be reported by one of several related measures. These include Word Error Rate (WER), Character Error Rate (CER), and Accuracy (1-WER). WER is the ratio of the reading mistakes, at the word level, among all test words, and CER measures the Levenshtein distance normalized by the length of the true word.

### From a Text Word to a Vector of Attributes

In the present Example, only common attributes that are shared between different words are considered.

One example of a set of binary attribute that can be used is the so-called Pyramidal Histogram of Characters (PHOC) introduced in Almazán et al. supra. The simplest attributes are based on unigrams and pertain to the entire word. An example of a binary attribute in English is “does the word contain the unigram ‘A’?” There are as many such attributes as the size of the character set of the benchmark that is employed. The character set may contain lower and upper case Latin alphabet, digits, accented letters (e.g., é, è, ê, ë, á, à, â, ä, etc.), Arabic alphabet, and the like. Attributes that check whether a word contains a specific unigram are referred to herein as Level-1 unigram attributes.

A Level-2 unigram attribute is defined as an attribute that observes whether a particular word contains a specific unigram in the first or second half of the word (e.g., “does the word contain the unigram ‘A’ in the first half of the word?”). For example, the word “BABY” contains the letter ‘A’ in the first half of the word (“BA”), but doesn't contain the letter ‘A’ in the second half of the word (“BY”).

In the present example, a letter declared to be inside a word segment if the segment contains at least 50% of the length of the word. For example, in the word “KID” the first half of the word contains the letters “K” and “I”, and the second half of the word contains the letters “I” and “D”.

Similarly, Level-n unigram attributes are also defined, breaking the word into n generally equal parts. In addition, Level-2 bigram attributes are defined as binary attributes that indicate whether the word contains a specific bigram, level-2 trigram attributes are defined as binary attributes that indicate whether the word contains a specific trigram, and so on. FIG. 5 illustrates an example of the attributes which are set for the word “optimization”. Note that since only common bigrams and trigrams have been used in this Example, not every bigram and trigram is defined as an attribute.

Other attributes were also used. These included attributes pertaining to the first letters or to the end of the word (e.g., “does the word end with an ‘ing’?”). The total number of attributes was selected to be sufficient so that every word in the benchmark dataset has a unique attributes vector. This bijective mapping was also used to map a given attributes vector to its respective generating word.

The basic set of attributes used in most of the experiments contained the unigram attributes based on the entire list of characters of each benchmark database, inspected in Levels-1 to Level-5, the 50 most common bigrams in Level-2, and the 20 most common trigrams in Level-2. Denoting the number of symbols in a character set of the respective benchmark by k, the total number of binary attributes was k(1+2+3+4+5)+50×2+20×2=15 k+140.

### Learning Attribute Vectors for Images

While the transformation from words to attributes is technical, the transformation from an image to an estimated vector of attributes is learned. In this Example, CNN has been used for the learning. This is unlike Almazán et al. in which per-attribute classifiers used. The advantage of using CNN is that it allows sharing the intermediate computations. Many of the attributes are similar in nature. For example, from the stand point of classification, the attribute “does the word contain the unigram ‘A’ in its first half?” is similar to the attribute “does the word contain the unigram ‘A’ in the second half of the word?” are similar. Both these attributes further relate to the attribute “does the word contain the bigram ‘AB’?”. A shared set of filters can be used to solve all these classification problems successfully, and so that the CNN benefits from solving multiple classification problems at once.

Compared to the approach described in Jaderberg et al., which enjoyed a very large training set, handwriting recognition is based on smaller datasets. The advantage of attributes in such cases is that the training set is utilized much more efficiently. For example, consider the case of a training set of size 1,000. The word “SLEEP” may appear only twice, but attributes such as “does the word contain the unigram ‘S’ in the first half of the word?” have many more instances. Therefore, learning to detect the attribute is easier to train than learning to detect the word. Since CNNs benefit substantially from a larger training set, the advantage of the attributes based method for handwriting recognition is significant.

Another advantage of learning attributes rather than the words themselves, is that similar words may confuse the network. For example, consider the words “KIDS” and “BIDS”. A “KIDS” word image is a negative sample for the “BIDS” category, although a large part of their appearance is shared. This similarity between some categories makes a category based classifier harder to learn, whereas an attribute-based classifier uses this for its advantage.

### Network Architecture

The basic layout of the CNN in the present Example is a VGG style network consisting of (3×3) convolution filters. Starting with an input image of size 100×32 pixels, a relatively deep network structure of 12 layers was used.

In the present Example, the CNN included nine convolutional layers and three fully connected layers. In forward order, the convolutional layers had 64, 64, 64, 128, 128, 256, 256, 512 and 512 filters of size 3×3. Convolutions were performed with a stride of 1, and there was input feature map padding by 1 pixel, to preserve the spatial dimension. The layout of the fully connected layers is detailed below. Maxout activation was used for each layer, including both the convolutional and the fully connected layers. Batch normalization was applied after each convolution, and before each maxout activation. The network also included 2×2 max-pooling layers, with a stride of 2, following the 3rd, 5th and 7th convolutional layers.

The fully connected layers of the CNN were separate and parallel. Each of the fully connected layers leads to a separate group of attribute predictions. The attributes were divided according to n-gram rank (unigrams, bigrams, trigrams), according to the levels (Level-1, Level-2, etc.), and according to the spatial locations associated with the attributes (first half of the word, second half of the word, first third of the word, etc.). For example, one collection of attributes contained Level-2, 2nd word-half, bigram attributes. Thus unlike traditional CNNs in which a single fully connected layer is used to generate the entire vector of attributes, the CNN of this Example includes 19 groups of attributes (1+2+3+4+5 for unigram based attributes at levels one to five, 2 for bigram based attributes at Level-2, and 2 for trigram based attributes at Level-2).

The layers leading up to this set of fully connected layers are all convolutional and are shared. The motivation for such network structure is that the convolutional layers learn to recognize the letters' appearance, regardless of their position in the word, and the fully connected layers learn the spatial information, which is typically the approximate position of the n-gram in the word. Hence, splitting the one fully connected layer into several parts, one per spatial section, allows the fully connected layers to specialize, leading to an improvement in accuracy.

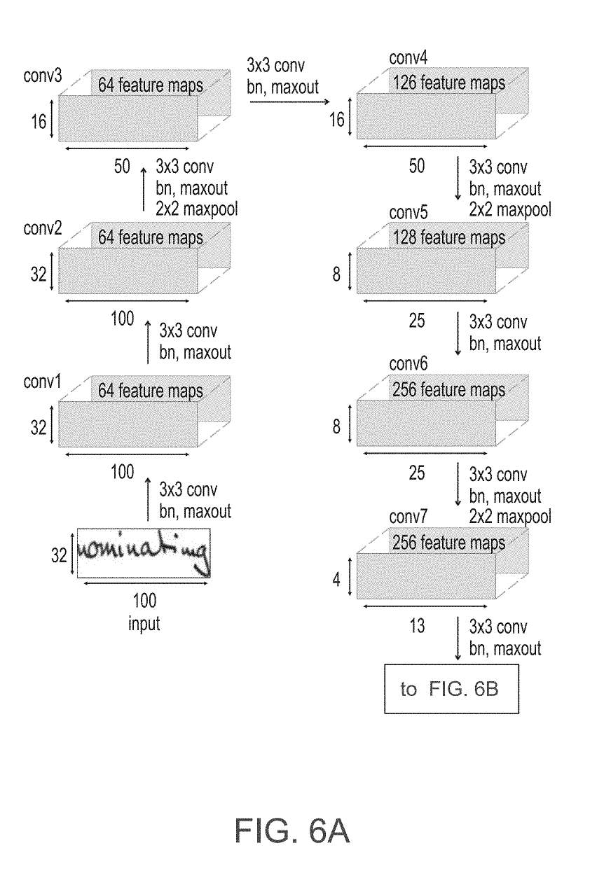

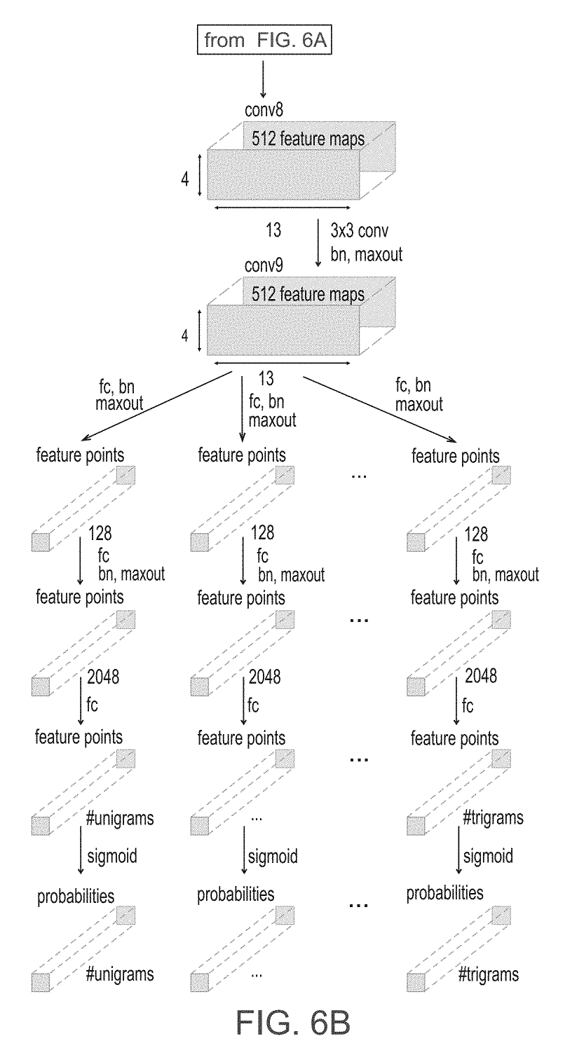

FIGS. 6A-B illustrates a structure of the CNN used in this Example. In 6A-B “bn” denotes batch normalization, and “fc” denotes fully connected. The output of the last convolutional layer (6B, conv9) is fed into 19 subnetworks referred to below as network branches. Each such network branch contains three fully connected layers. In each network branch, the first fully connected layer had 128 units, the second fully connected layer had 2048 units, and the number of units in the third fully connected layer was selected in accordance with the number of binary attributes in the respective benchmark dataset. Specifically, for unigram-based groups the number of units in the third fully connected layer was equal to the size of the character set (52 for IAM, 78 for RIMES, 44 for IFN/ENIT, and 36 for SVT). For bigram-based groups the number of units in the third fully connected layer was 50, and for trigram based groups the number of units in the third fully connected layer was 20. The activations of the last layer were transformed into probabilities using a sigmoid function.

### Training and Implementation

The network was trained using the aggregated sigmoid cross-entropy (logistic) loss. Stochastic Gradient Descent (SGD) was employed as optimization method, with a momentum set to 0.9, and dropout after the two fully connected hidden layers with a parameter set to 0.5. An initial learning rate of 0.01 was used, and was lowered when the validation set performance stopped improving. Each time the learning rate was divided by 10, with this process repeated three times. The batch size was set in the range of 10 to 100, depending on the dataset on which the CNN was trained and on the memory load. When enlarging the network and adding more fully connected layers, the GPU memory becomes congested and the batch size was lowered. The network weights were initialized using Glurot and Bengio's initialization scheme.

The training was performed in stages, by gradually adding more attributes groups as the training progressed. For example, training was performed only for the Level-1 unigrams, using a single network branch of fully connected layers. When the loss stabilized, another group of attributes was added and the training continued. Groups of attributes were may added in the following order: Level-1 unigrams, Level-2 unigrams, . . . , Level-5 unigrams, Level-2 bigrams, and Level-2 trigrams. During group addition the initial learning rate was used. Once all 19 groups were added, the learning rate was lowered. It was found by the Inventors that this gradual way of training generates considerably superior results over the alternative of directly training on all the attributes groups at once.

For the synthetic SVT dataset, incremental training was employed. Specifically, the network was trained using 10 k images out of the 7 M images until partial convergence. The training was then continued using 100 k images until partial convergence. This process was repeated with 200 k and 1 M, and finally the network was trained on the entire dataset. This procedure was selected since it is difficult to achieve convergence when training the network on the entire dataset without gradual training.

### Regularization and Training Data Augmentation

To avoid overfitting, dropout has been applied after the first and second fully connected layers of each network branch. A weight decay of 0.0025 has applied to learned weights.

The inputs to the exemplary network are grayscale images 100×32 pixels in size. Images having different sizes were stretched to this size without preserving the aspect ratio. Since the handwriting datasets are rather small and the neural network to be trained is a deep CNN with tens of millions of parameters, data augmentation has been employed.

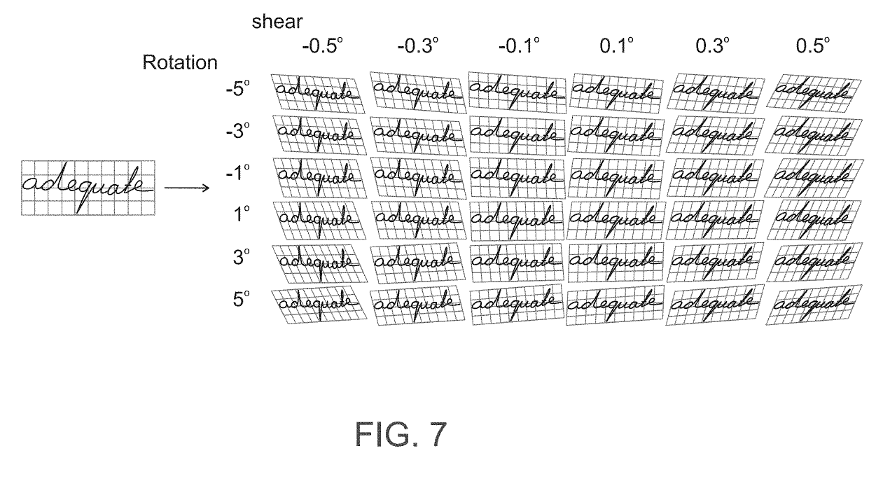

The data augmentation was performed as follows. For each input image, rotations around the image center were applied with each of the following angles (degrees): −5°, −3°, −1°, +1°, +3° and +5°. In addition, shear was applied using the following angles −0.5°, −0.3°, −0.1°, 0.1°, 0.3°, 0.5°. By these manipulations, 36 additional images are generated for each input image, thereby increasing the amount of training data. This image augmentation process is described in FIG. 7. Also contemplated are other manipulations, such as, but not limited to, elastic distortion and the like.

Each word in the lexicon was represented by a vector of attributes. This process was executed only once. In the experiments performed by the Inventors, the test data were augmented as well, using the same augmentation procedure described above, so that each image of the lexicon was characterized by 37 vectors of attributes. The final representation of each image of the lexicon was taken to be the mean vector of all 37 representations.

An input image was received by the CNN to provide a set of predicted attributes. One can then directly compare the set of predicted attributes to the attributes of the lexicon words. However, the network was trained for a per-feature success and not for matching lexical words. Additionally, such a direct comparison may not exploit correlations that may exist between the various coordinates due to the nature of the attributes. For example, a word which contains the letter ‘A’ in the first third of the word, will always contain the letter ‘A’ in the first half of the word. Further, a direct comparison may be less accurate since some attributes or subsets of attributes may have higher discriminative power than other attributes or subsets of attributes. Still further, for efficient a direct comparison, it is oftentimes desired to calibrate the output probabilities of the CNN.

Thus, while direct comparison can be used for recognizing the textual content of the input image, it was found by the Inventors that Canonical Correlation Analysis (CCA) is a more preferred technique. The CCA was applied to learn a common linear subspace to which both the attributes of the lexicon words and the network representations are projected. The network representations can be either the predicted attributes probabilities, or a concatenation of parallel fully connected layers from two or more of, more preferably all, the branches of the network.

The shared subspace was learned such that images and matching words are projected as close as possible. In the present Example, a regularized CCA method was employed. The regularization parameter was fixed to be the largest eigenvalue of the cross correlation matrix between the network representations and the matching vectors of the lexicon.

Note that CCA does not require that the matching vectors of the two domains are of the same type or the same size. This property of CCA was exploited by the Inventors by using the CNN itself rather than its attribute probability estimations. Specificity, the activations of a layer below the classification were used instead of the probabilities. In the present Example, the concatenation of the second fully connected layers from all branches of the network was used. When the second fully connected layers were used instead of the probabilities, the third and output layers were used only for training, but not during the prediction.

In the network of the present Example, the second fully connected layer in each of the 19 branches has 2,048 units, so that the subset to be analyzed for canonical correlation included a total number of 38,912 units. To reduce computer resources, a vector of 12,000 elements was randomly sampled out of the 38,912, and the CCA was applied to the sampled vector. A very small change (less than 0.1%) was observed when resampling the subset. The input to the CCA algorithm was L2-normalized, and the cosine distance was used, so as to efficiently find the nearest neighbor in the shared space.

### Results

The results are presented on the commonly used handwriting recognition benchmarks. The datasets used were: IAM, RIMES and IFN/ENIT, which contain images of handwritten English, French and Arabic, respectively. The same exemplary network was used in all cases, using the same parameters. Hence, no language specific information was needed except for the character set of the benchmark.

The IAM Handwriting Database [34] is a known offline handwriting recognition database of English word images. The database contains 115,320 words written by 500 authors. The database comes with a standard split into train, validation and test sets, such that every author contributes to only one set. It is not possible that the same author would contribute handwriting samples to both the train set and the test set.

The RIMES database [5] contains more than 60,000 words written in French by over 1000 authors. The RIMES database has several versions with each one a superset of the previous one. In the experiments reported herein, the latest version presented in the ICDAR 2011 contest has been used.

The IFN/ENIT database [42] contains several sets and has several scenarios that can be tested and compared to other works. The most common scenarios are: “abcde-f”, “abcde-s”, “abcd-e” (older) and “abc-d” (oldest). The naming convention specifies the train and the test sets. For example, the “abcde-f” scenario refers to a train set comprised of the sets a, b, c, d, and e, wherein the testing is done on set f.

Two additional benchmarks including printed text images have been used. These included the two Street View Text (SVT) datasets [54]. The first SVT dataset uses a general lexicon, and the second SVT dataset, known as the SVT-50 subset, uses a subset of 50 words of the general lexicon.

On the IAM and RIMES datasets, the lexicon of all the dataset words (both train and test sets) was used. On the IFN/ENIT dataset, the official lexicon attached to the benchmark was used. On the first SVT dataset, a general lexicon of 90 k words [26, 25] was used. On the SVT-50 dataset the 50 words lexicon associated with this reduced benchmark were used.

The prediction obtained by CNN and CCA was compared with the actual image transcription. The different benchmark datasets use several different measures as further detailed below. To ease the comparison, the most common measure among the respective dataset is used for the comparison. Specifically, on the IAM and RIMES datasets, the results are shown using the WER and CER measures, and on the IFN/ENIT and SVT datasets, the results are shown using the accuracy measure.

Since the benchmarks are in different languages, different character sets were used. Specifically, for the IAM dataset, the character set contained the lower and upper case Latin alphabet. Digits were not included since they are rarely used in this dataset. However, when they appear they were not ignored. Therefore, if a prediction was different from the ground truth label only by a digit, it was still considered a mistake. In the RIMES dataset, the character set used contained the lower and upper case Latin alphabet, digits and accented letters. In the IFN/ENIT dataset, the character set was built out of the set of all unigrams in the dataset. This includes the Arabic alphabet, digits and symbols. In the SVT dataset the character set used contains the Latin alphabet, disregarding case, and digits.

The network used for SVT was slightly different from the networks used for handwriting recognition. Since the synthetic dataset used to train for the SVT benchmark has many training images, the size of the network was reduced in order to lower the running time of each epoch. Specifically, the depth of all convolutional layers was cut by half. The depth of the fully connected layer was doubled to partly compensate for the lost complexity.

Tables 1 and 2 below compares the performances obtained for the IAM and RIMES dataset (Table 1) and the IFN/ENIT dataset (Table 2). The last entry in each of Table 1 and 2 corresponds to performances obtained using the embodiments described in this Example. Table 1 shows WER and CER values and Table 2 shows accuracy in percents.

TABLE 1

| Database | IAM | | RIMES | |
|---|---|---|---|---|
| Model | WER | CER | WER | CER |
| Bertolami and Bunke [8] | 32.80 | | | |
| Dreuw et al. [13] | 28.80 | 10.10 | | |
| Boquera et al. [15] | 15.50 | 6.90 | | |
| Telecom ParisTech [22] | | | | 24.88 |
| IRISA [22] | | | 21.41 | |
| Jouve [22] | | | 12.53 | |
| Kozielski et al. [29] | 13.30 | 5.10 | 13.70 | 4.60 |
| Almazan et al. [3] | 20.01 | 11.27 | | |
| Messina and Kermorvant [37] | 19.40 | | 13.30 | |
| Pham et al. [45] | 13.60 | 5.10 | 12.30 | 3.30 |
| Bluche et al. [10] | 20.50 | | 9.2 | |
| Doetsch et al. [12] | 12.20 | 4.70 | 12.90 | 4.30 |
| Bluche et al. [11] | 11.90 | 4.90 | 11.80 | 3.70 |
| Menasri et al. (single) [35] | | | 8.90 | |
| Menasri et al. (7 combined) [35] | | | 4.75 | |
| This Example | 6.45 | 3.44 | 3.90 | 1.90 |

TABLE 2

| Database | IFN/ENIT | | | |
|---|---|---|---|---|
| Scenario | abc-d | abcd-e | a . . . e-f | a . . . e-s |
| Pechwitz & Maergner [43] | 89.74 | | | |
| Alabodi & Li [2] | 93.30 | | | |
| Lawgali et al. [30] | | 90.73 | | |
| SIEMENS [41] | | | 82.22 | 73.94 |
| Dreuw et al. [13] | 96.50 | 92.70 | 90.90 | 81.10 |
| Graves&Schmidhuber [21] | | | 91.43 | 78.83 |
| UPV PRHLT [33] | | | 92.20 | 84.62 |
| Graves&Schmidhuber [14] | | | 93.37 | 81.06 |
| RWTH-OCR [32] | | | 92.20 | 84.55 |
| Azeem & Ahmed [6] | 97.70 | 93.44 | 93.10 | 84.80 |
| Ahmad et al. [1] | 97.22 | 93.52 | 92.15 | 85.12 |
| Stahlberg & Vogel [49] | 97.60 | 93.90 | 93.20 | 88.50 |
| This Example | 99.29 | 97.07 | 96.76 | 94.09 |

Tables 1 and 2 demonstrate that the technique presented in this Example achieves state of the art results on all benchmark datasets, including all versions of the IFN/ENIT benchmark. The improvement over the state of the art, in these competitive datasets, is such that the error rates are cut in half throughout the datasets: IAM (6.45% vs. 11.9%), RIMES (3.9% vs. 8.9% for a single recognizer), IFN/ENIT set-f (3.24% vs. 6.63%) and set-s (5.91% vs. 11.5%).

Table 3 below compares the performances obtained for the SVT dataset. The last entry in each of Table 3 corresponds to performances obtained using the embodiments described in this Example.

TABLE 3

| Database | SVT-50 | SVT |
|---|---|---|
| Model | Accuracy (%) | Accuracy (%) |
| ABBYY [36] [53] | 35.0 | |
| Wang et al. [53] | 57.0 | |
| Mishra et al. [38] | 73.57 | |
| Novikova et al. [40] | 72.9 | |
| Wang et al. [55] | 70.0 | |
| Goel et al. [18] | 77.28 | |
| PhotoOCR [9] | 90.39 | 77.98 |
| Alsharif and Pineau [4] | 74.3 | |
| Almazán et al. [3] | 89.18 | |
| Yao et al. [56] | 75.89 | |
| Jaderberg et al. [27] | 86.1 | |
| Gordo [20] | 91.81 | |
| Jaderberg et al. [25] | 95.4 | 80.7 |
| This work | 95.05 | 81.92 |

Table 3 demonstrates that the technique presented in this Example achieves state of the art results when using the same global 90 k dictionary used in [26], and a comparable result (only 2 images difference) to the state of the art on the small lexicon variant SVT-50. The accuracy on the test set of the synthetic data has also been compared. A 96.55% accuracy has been obtained using the technique presented in this Example, compared to 95.2% obtained by the best network of [26].

Table 4, below, shows comparison among several variants of the technique presented in this Example. In Table 4, full CNN corresponds to 19 branches of fully connected layers, with bigrams and trigrams, with test-side data augmentation, wherein the input to the CCA was the concatenated fully connected layer FC. Variant I corresponds to the full CNN but using the CCA on aggregated probability vectors rather than the hidden layers. Variant II corresponds to the full CNN but without trigrams during test. Variant III corresponds to the full CNN but without bigrams and trigrams during test. Variant IV corresponds to the full CNN but without trigrams during training. Variant V corresponds to the full CNN but without bigrams and trigrams during training. Variant VI corresponds to the full CNN but using 7 branches instead of 19 branches, wherein related attributes groups are merged. Variant VII corresponds to the full CNN but 1 branch instead of 19 branches, wherein all attributes groups are merged to a single group. Variant VIII corresponds to the full CNN but without test-side data augmentation. For reasons of table consistency, the performances for the IFN/ENIT dataset are provided in terms of WER instead of Accuracy (1-WER).

TABLE 4

| | Database | | | | | | | |
|---|---|---|---|---|---|---|---|---|
| | | | | | IFN/ENIT | | | |
| | | | | | Scenario | | | |
| | IAM | | RIMES | | abc-d | abcd-e | abcde-f | abcde-s |
| | Model | | | | | | | |
| | WER | CER | WER | CER | WER | WER | WER | WER |
| Full CNN | 6.45 | 3.44 | 3.90 | 1.90 | 0.71 | 2.93 | 3.24 | 5.91 |
| Variant I | 6.56 | 3.46 | 3.85 | 1.73 | 0.65 | 2.88 | 3.18 | 6.42 |
| Variant II | 6.33 | 3.34 | 3.95 | 1.86 | 0.71 | 2.90 | 3.18 | 6.10 |
| Variant III | 6.29 | 3.37 | 3.78 | 1.89 | 0.68 | 2.95 | 3.17 | 6.10 |
| Variant IV | 6.32 | 3.33 | 4.15 | 1.91 | 0.68 | 2.80 | 3.23 | 5.91 |
| Variant V | 6.36 | 3.36 | 3.85 | 1.82 | 0.61 | 2.69 | 3.11 | 5.85 |
| Variant VI | 7.16 | 3.95 | 4.93 | 2.34 | 0.74 | 3.83 | 3.45 | 6.48 |
| Variant VII | 7.81 | 4.33 | 4.93 | 2.31 | 1.48 | 11.09 | 4.77 | 7.63 |
| Variant VIII | 6.94 | 3.71 | 4.27 | 2.02 | 0.73 | 3.12 | 3.37 | 6.42 |

Table 4 demonstrates that the technique of the present embodiments is robust to various design choices. For example, using CCA on the aggregated probability vectors (variant I) provide a compatible level of performance. Similarly, bigrams and trigrams do not seem to consistently affect the performance, neither when removed only from the test stage, nor when removed from both training and test stages. Nevertheless, reducing the number of branches from 19 to 7 by merging related attributes groups (e.g., using a single branch for all level 5 unigram attributes instead of 5 branches), or to one branch of fully connected hidden layers, reduces the performance. Increasing the number of hidden units in order to make the total number of hidden units the same (data not shown) hinders convergence during training. Test-side data augmentation seems to improve performance.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

[1] I. Ahmad, G. Fink, S. Mahmoud, al. Improvements in sub-character hmm model based arabic text recognition. In Frontiers in Handwriting Recognition (ICFHR), 2014 14th International Conference on, pages 537-542. IEEE, 2014.
[2] J. Alabodi and X. Li. An effective approach to offline arabic handwriting recognition. International Journal of Artificial Intelligence & Applications, 4(6):1, 2013.
[3] J. Almazan, A. Gordo, A. Fornes, and E. Valveny. Word spotting and recognition with embedded attributes. IEEE Transactions on Pattern Analysis & Machine Intelligence, (12):2552-2566, 2014.
[4] O. Alsharif and J. Pineau. End-to-end text recognition with hybrid hmm maxout models. arXiv preprint arXiv:1310.1811, 2013.
[5] E. Augustin, M. Carré, E. Grosicki, J.-M. Brodin, E. Geof-frois, and F. Prêteux. Rimes evaluation campaign for hand-written mail processing. In Proceedings of the Workshop on Frontiers in Handwriting Recognition, number 1,2006.
[6] S. A. Azeem and H. Ahmed. Effective technique for the recognition of offline arabic handwritten words using hidden markov models. International Journal on Document Analysis and Recognition (IJDAR), 16(4):399-412, 2013.
[7] Y. Bengio, J. Louradour, R. Collobert, and J. Weston. Curriculum learning.
In Proceedings of the 26th Annual Inter-national Conference on Machine Learning, ICML '09, pages 41-48, New York, N.Y., USA, 2009. ACM.
[8] R. Bertolami and H. Bunke. Hidden markov model-based ensemble methods for offline handwritten text line recognition. Pattern Recognition, 41(11):3452-3460, 2008.
[9] A. Bissacco, M. Cummins, Y. Netzer, and H. Neven. Pho-toocr: Reading text in uncontrolled conditions. In Computer Vision (ICCV), 2013 IEEE International Conference on, pages 785-792. IEEE, 2013.
[10] T. Bluche, H. Ney, and C. Kermorvant. Tandem hmm with convolutional neural network for handwritten word recognition. In Acoustics, Speech and Signal Processing (ICASSP), 2013 IEEE International Conference on, pages 2390-2394. IEEE, 2013.
[11] T. Bluche, H. Ney, and C. Kermorvant. A comparison of sequence-trained deep neural networks and recurrent neural networks optical modeling for handwriting recognition. In Statistical Language and Speech Processing, pages 199-210. Springer, 2014.
[12] P. Doetsch, M. Kozielski, and H. Ney. Fast and robust training of recurrent neural networks for offline handwriting recognition. In Frontiers in Handwriting Recognition (ICFHR), 2014 14th International Conference on, pages 279-284. IEEE, 2014.
[13] P. Dreuw, P. Doetsch, C. Plahl, and H. Ney. Hierarchical hybrid MLP/HMM or rather MLP features for a discriminatively trained gaussian HMM: a comparison for offline handwriting recognition. In Image Processing (ICIP), 2011 18th IEEE International Conference on, pages 3541-3544. IEEE, 2011.
[14] H. El Abed and V. Margner. Icdar 2009-arabic handwriting recognition competition. International Journal on Document Analysis and Recognition (IJDAR), 14(1):3-13, 2011.
[15] S. Espana-Boquera, M. J. Castro-Bleda, J. Gorbe-Moya, and F. Zamora-Martinez. Improving offline handwritten text recognition with hybrid HMM/ANN models. Pattern Analysis and Machine Intelligence, IEEE Transactions on, 33(4):767-779, 2011.
[16] J. G. Fiscus. A post-processing system to yield reduced word error rates: Recognizer output voting error reduction (rover). In Automatic Speech Recognition and Understanding, 1997. Proceedings., 1997 IEEE Workshop on, pages 347-354. IEEE, 1997.
[17] X. Glorot and Y. Bengio. Understanding the difficulty of training deep feedforward neural networks. In International conference on artificial intelligence and statistics, pages 249-256, 2010.
[18] V. Goel, A. Mishra, K. Alahari, and C. Jawahar. Whole is greater than sum of parts: Recognizing scene text words. In Document Analysis and Recognition (ICDAR), 2013 12th International Conference on, pages 398-402. IEEE, 2013.
[19] I. J. Goodfellow, D. Warde-Farley, M. Mirza, A. Courville, and Y. Bengio. Maxout networks. arXiv preprint arXiv:1302.4389, 2013.
[20] A. Gordo. Supervised mid-level features for word image representation. arXiv preprint arXiv:1410.5224, 2014.
[21] A. Graves and J. Schmidhuber. Offline handwriting recognition with multidimensional recurrent neural networks. In Advances in Neural Information Processing Systems, pages 545-552, 2009.
[22] E. Grosicki and H. El-Abed. ICDAR 2011: French handwriting recognition competition. In Proc. of the Int. Conf. on Document Analysis and Recognition, pages 1459-1463, 2011.
[23] K. He, X. Zhang, S. Ren, and J. Sun. Delving deep into rectifiers: Surpassing human-level performance on imagenet classification. CoRR, abs/1502.01852, 2015.
[24] S. loffe and C. Szegedy. Batch normalization: Accelerating deep network training by reducing internal covariate shift. arXiv preprint arXiv:1502.03167, 2015.
[25] M. Jaderberg, K. Simonyan, A. Vedaldi, and A. Zisserman. Reading text in the wild with convolutional neural networks. International Journal of Computer Vision, pages 1-20, 2014.
[26] M. Jaderberg, K. Simonyan, A. Vedaldi, and A. Zisserman. Synthetic data and artificial neural networks for natural scene text recognition. arXiv preprint arXiv:1406.2227, 2014.
[27] M. Jaderberg, A. Vedaldi, and A. Zisserman. Deep features for text spotting. In Computer Vision—ECCV 2014, pages 512-528. Springer, 2014.
[28] Y. Jia, E. Shelhamer, J. Donahue, S. Karayev, J. Long, R. Gir-shick, S. Guadarrama, and T. Darrell. Caffe: Convolutional architecture for fast feature embedding. arXiv preprint arXiv:1408.5093, 2014.
[29] M. Kozielski, P. Doetsch, and H. Ney. Improvements in rwth's system for off-line handwriting recognition. In Document Analysis and Recognition (ICDAR), 2013 12th Inter-national Conference on, pages 935-939. IEEE, 2013.
[30] A. Lawgali, M. Angelova, and A. Bouridane. A framework for arabic handwritten recognition based on segmentation. International Journal of Hybrid Information Technol-ogy, 7(5):413-428, 2014.
[31] Y. LeCun, L. Bottou, Y. Bengio, and P. Haffner. Gradient-based learning applied to document recognition. Proceed-ings of the IEEE, 86(11):2278-2324, 1998.
[32] V. Margner and H. Abed. Icdar 2011-arabic handwriting recognition competition. In Document Analysis and Recognition (ICDAR), 2011 International Conference on, pages 1444-1448.
[33] V. Margner and H. E. Abed. Icfhr 2010-arabic handwriting recognition competition. In Frontiers in Handwriting Recognition (ICFHR), 2010 International Conference on, pages 709-714. IEEE, 2010.
[34] U. V. Marti and H. Bunke. The iam-database: an english sentence database for offline h andwriting r ecognition. International Journal on Document Analysis and Recognition, 5(1):39-46, 2002.
[35] F. Menasri, J. Louradour, A. Bianne-Bernard, and C. Ker-morvant. The A2iA French handwriting recognition system at the Rimes-ICDAR2011 competition. In Proceedings of SPIE, volume 8297, 2012.
[36] E. Mendelson. Abbyy finereader professional 9.0. PC Magazine, 2008.
[37] R. Messina and C. Kermorvant. Over-generative finite state transducer n-gram for out-of-vocabulary word recognition. In Document Analysis Systems (DAS), 2014 11th IAPR International Workshop on, pages 212-216. IEEE, 2014.
[38] A. Mishra, K. Alahari, and C. Jawahar. Scene text recognition using higher order language priors. In BMVC 2012-23rd British Machine Vision Conference. BMVA, 2012.
[39] Y. Movshovitz-Attias, Q. Yu, M. C. Stumpe, V. Shet, S. Arnoud, and L. Yatziv. Ontological supervision for fine grained classification of street view s torefronts. In Proceedings of the IEEE Conference on Computer Vision and Pattern Recognition, pages 1693-1702, 2015.
[40] T. Novikova, O. Barinova, P. Kohli, and V. Lempitsky. Large-lexicon attribute-consistent text recognition in natural images. In Computer Vision—ECCV 2012, pages 752-765. Springer, 2012.
[41] M. Pechwitz, S. Maddouri, V. Ma\ddot{}gner, N. Ellouze, and H. Amiri. Icdar 2007 arabic handwriting recognition competition. In Colloque International Francophone sur l'Ecrit et le Document (CIFED), Hammamet, Tunis, 2002.
[42] M. Pechwitz, S. S. Maddouri, V. Ma\ddot{}rgner, N. Ellouze, H. Amiri, et al. IFN/ENIT database of handwritten arabic words. Citeseer.
[43] M. Pechwitz and V. Maergner. Hmm based approach for handwritten arabic word recognition using the IFN/ENIT database. In null, page 890. IEEE, 2003.
[44] F. Perronnin, J. Sa´nchez, and T. Mensink. Improving the fisher k ernel f or large-scale image classification. In Computer Vision—ECCV 2010, pages 143-156. Springer, 2010.
[45] V. Pham, T. Bluche, C. Kermorvant, and J. Louradour. Dropout improves recurrent neural networks for handwriting recognition. In Frontiers in Handwriting Recognition (ICFHR), 2014 14th International Conference on, pages 285-290. IEEE, 2014.
[46] P. Y. Simard, D. Steinkraus, and J. C. Platt. Best practices for convolutional neural networks applied to visual document analysis. In null, page 958. IEEE, 2003.
[47] K. Simonyan and A. Zisserman. Very deep convolutional networks for large-scale image recognition. arXiv preprint arXiv:1409.1556, 2014.
[48] N. Srivastava, G. Hinton, A. Krizhevsky, I. Sutskever, and R. Salakhutdinov. Dropout: A simple way to prevent neural networks from overfitting. The Journal of Machine Learning Research, 15(1):1929-1958, 2014.
[49] F. Stahlberg and S. Vogel. The qcri recognition system for handwritten arabic. In Image Analysis and Processing ICIAP 2015, pages 276-286. Springer, 2015.
[50] C. Szegedy, W. Liu, Y. Jia, P. Sermanet, S. Reed, D. Anguelov, D. Erhan, V. Vanhoucke, and A. Rabinovich. Going deeper with convolutions. CoRR, abs/1409.4842, 2014.
[51] Y. Taigman, M. Yang, M. Ranzato, and L. Wolf. Deepface: Closing the gap to human-level performance in face verification. June 2014.
[52] H. Vinod. Canonical ridge and econometrics of joint production. Journal of Econometrics, 4(2):147-166, 1976.
[53] K. Wang, B. Babenko, and S. Belongie. End-to-end scene text recognition. In Computer Vision (ICCV), 2011 IEEE International Conference on, pages 1457-1464. IEEE, 2011.
[54] K. Wang and S. Belongie. Word spotting in the wild. Springer, 2010.
[55] T. Wang, D. J. Wu, A. Coates, and A. Y. Ng. End-to-end text recognition with convolutional neural networks. In Pattern Recognition (ICPR), 2012 21st International Conference on, pages 3304-3308. IEEE, 2012.
[56] C. Yao, X. Bal, B. Shi, and W. Liu. Strokelets: A learned multi-scale representation for scene text recognition. In Computer Vision and Pattern Recognition (CVPR), 2014 IEEE Conference on, pages 4042-4049. IEEE, 2014.

1. A method of converting an input image patch to a text output, comprising:
applying a convolutional neural network (CNN) to the input image patch to estimate an n-gram frequency profile of the input image patch;
accessing a computer-readable database containing a lexicon of textual entries and associated n-gram frequency profiles;
searching said database for an entry matching said estimated frequency profile; and
generating a text output responsively to said matched entries.

2. The method according to claim 1, wherein said CNN is applied directly to raw pixel values of the input image patch.

3. The method according to claim 1, wherein at least one of said n-grams is a sub-word.

4. The method according to claim 1, wherein said CNN comprises a plurality of subnetworks, each trained for classifying the input image patch into a different subset of attributes.

5. (canceled)

6. The method according to claim 1, wherein said CNN comprises a plurality of convolutional layers trained for determining existence of n-grams in the input image patch, and a plurality of parallel subnetworks being fed by said convolutional layers and trained for determining a position of said n-grams in the input image patch.

7. (canceled)

8. The method according to claim 6, wherein each of said subnetworks comprises a plurality of fully-connected layers.

9. (canceled)

10. The method according to claim 1, wherein said CNN comprises multiple parallel fully connected layers.

11. (canceled)

12. The method according to claim 10, wherein said CNN comprises a plurality of subnetworks, each subnetwork comprising a plurality of fully connected layers, and being trained for classifying the input image patch into a different subset of attributes.

13. (canceled)

14. The method of claim 12, wherein for at least one of said subnetworks, said subset of attributes comprises a rank of an n-gram, a segmentation level of the input image patch, and a location of a segment of the input image patch containing said n-gram.

15. (canceled)

16. The method according to claim 1, wherein said searching comprises applying a canonical correlation analysis (CCA).

17. (canceled)

18. The method according to claim 16, wherein the method comprises obtaining a representation vector directly from a plurality of hidden layers of said CNN, and wherein said CCA is applied to said representation vector.

19. (canceled)

20. The method according to claim 18, wherein said plurality of hidden layers comprises multiple parallel fully connected layers, and wherein said representation vector is obtained from a concatenation of said multiple parallel fully connected layers.

21. (canceled)

22. The method according to claim 1, wherein the input image patch contains a handwritten word.

23. (canceled)

24. The method according to claim 1, further comprising receiving the input image patch from a client computer over a communication network, and transmitting the text output to the client computer over said communication network to be displayed on a display by the client computer.

25. (canceled)

26. A method of converting an image containing a corpus of text to a text output, the method comprising:
dividing the image into a plurality of image patches; and
for each image patch, executing the method according to claim 1 using said image patch as the input image patch, to generate a text output corresponding to said patch.

27. (canceled)

28. The method according to claim 26, further comprising receiving the image containing the corpus of text from a client computer over a communication network, and transmitting the text output corresponding to each patch to the client computer over said communication network to be displayed on a display by the client computer.

29. (canceled)

30. A method of extracting classification information from a dataset, the method comprising:
training a convolutional neural network (CNN) on the dataset, the CNN having a plurality of convolutional layers, and a first subnetwork containing at least one fully connect layer and being fed by said convolutional layers;
enlarging said CNN by adding thereto a separate subnetwork, also containing at least one fully connect layer, and also being fed by said convolutional layers, in parallel to said first subnetwork; and
training said enlarged CNN on the dataset.

31. The method of claim 30, wherein the dataset is a dataset of images.

32. The method of claim 31, wherein the dataset is a dataset of images containing handwritten symbols.

33. (canceled)

34. A computer software product, comprising a computer-readable medium in which program instructions are stored, which instructions, when read by a server computer, cause the server computer to receive an input image patch and to execute the method according to claim 1.
